(19) United States
(12) Patent Application Publication
(10) Pub. No.: US 2020/0221197 A1
(43) Pub. Date: Jul. 9, 2020

(54) SPEAKER

(71) Applicant: Tymphany Acoustic Technology (Huizhou) Co., Ltd., Huizhou City (CN)

(72) Inventor: Christoph von Hellermann, Huizhou City (CN)

(21) Appl. No.: 16/411,779

(22) Filed: May 14, 2019

(30) Foreign Application Priority Data
Jan. 4, 2019 (CN) 201910008574.6

(51) Int. Cl. H04R 1/02

(52) U.S. Cl. CPC H04R 1/025

(57) ABSTRACT

A speaker includes an acoustic conversion module and a sound pickup module. The acoustic conversion module includes a first outer casing that is substantially cylindrical. The sound pickup module includes a second outer casing that is substantially annular, and the second casing includes an accommodating portion. The upper edge of the acoustic conversion module is located at the accommodating portion and couples the first outer casing with the second outer casing by a coupling member to detachably couple the sound pickup module to the acoustic conversion module.

### CROSS REFERENCE TO RELATED APPLICATIONS

This application claims priority of Application No. CN 201910008574.6 filed in China on Jan. 4, 2019 under 35 U.S.C. § 119, the entire contents of all of which are hereby incorporated by reference.

### TECHNICAL FIELD

The present application relates to a speaker, in particular, to a speaker that is easy to expand and replace the sound pickup module.

### BACKGROUND

Modular processes and sales have always been the goal of every product, as modularity simplifies processes and increases product flexibility.

In terms of speakers, the current needs are constantly increasing, for example, users want to increase a voice control mode. Then, a speaker with a microphone is required, but the voice control mode is not a function required by a conventional speaker. Therefore, for the speaker industry, if the microphone can be modularized, it can reduce such trouble. Moreover, after the general speaker is miniaturized, when the microphone is too close to the sounding assembly, an echo interference may be caused.

### SUMMARY

The present application provides a speaker comprising an acoustic conversion module and a sound pickup module. The acoustic conversion module includes a first outer casing that is substantially cylindrical. The sound pickup module includes a second outer casing that is substantially annular, and the second casing includes an accommodating portion; the upper edge of the acoustic conversion module is located at the accommodating portion, and couples the first outer casing with the second outer casing by a coupling member to detachably couple the sound pickup module to the acoustic conversion module.

In an embodiment, the sound pickup module includes a circuit assembly, and the circuit assembly includes at least one microphone, wherein the second casing encloses the circuit assembly.

In an embodiment, the circuit assembly includes a processor, and the processor is electrically coupled to the at least one microphone. In an embodiment, the circuit member includes a Bluetooth module, and the processor is electrically connected to the Bluetooth module.

In an embodiment, the circuit assembly includes a network module, and the processor is electrically coupled to the network module.

In an embodiment, the circuit assembly includes an amplifier, and the amplifier is coupled to the processor.

In an embodiment, the first outer casing is substantially circular, elliptical, square or rectangular columnar, and the second outer casing is concentric with the first outer casing and is circular, elliptical, square or rectangular annular.

In an embodiment, the coupling member includes a screw lock attachment.

In an embodiment, the coupling member includes a hook structure, a groove structure, or a spiral engagement structure.

In an embodiment, the first outer casing includes an upper edge extending outwardly, and the sound pickup module is detachably coupled to the upper edge of the acoustic conversion module.

### BRIEF DESCRIPTION OF THE DRAWINGS

FIG. 1 is a perspective view of the appearance of a speaker of the present application.

FIG. 2 is an exploded view of the speaker according to FIG. 1.

FIG. 3 is an exploded view of a sound pickup module in accordance with the present application.

FIG. 4 is a front view of a coupling member in hook structure of the speaker of the present application.

FIG. 5 is a front view of a coupling member in groove structure of the speaker of the present application.

FIG. 6 is a front view of a coupling member in spiral snapping structure of the speaker of the present application.

FIG. 7 is a view showing the first outer casing of the speaker of the present application in a square shape.

FIG. 8 is a view showing the first outer casing of the speaker of the present application in an elliptical shape.

### DETAILED DESCRIPTION OF THE EMBODIMENTS

In order to fully understand the purposes, features and effects of the present application, the present application will be described in detail by the following specific embodiments,

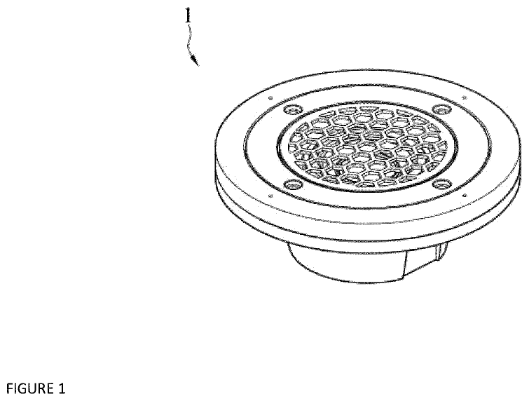

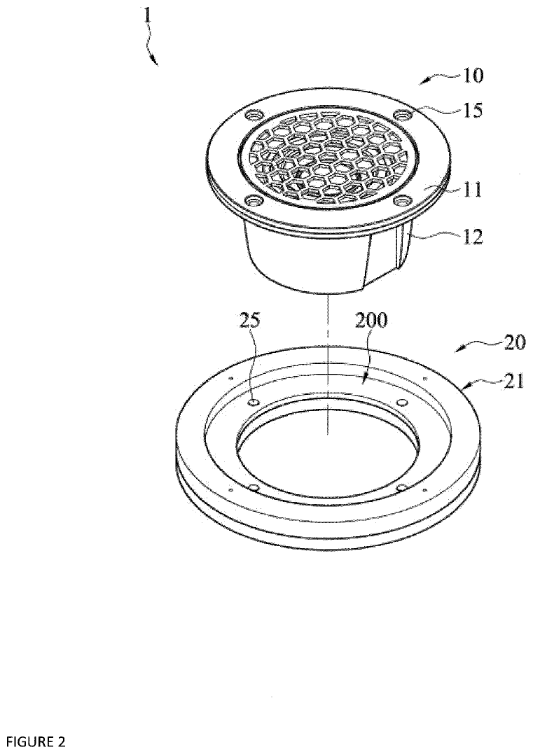

With reference to FIG. 1, the present application provides a speaker 1. With reference to FIG. 2, the speaker 1 comprises an acoustic conversion module 10 and a sound pickup module 20. The acoustic conversion module 10 includes a first outer casing 12 that is substantially cylindrical, and the first outer casing 12 includes an upper edge 11 extending outwardly. The sound pickup module 20 includes a second outer casing 21 that is substantially annular, and the second casing 21 includes an accommodating portion 200. When the acoustic conversion module 10 is combined with the sound pickup module 20, the upper edge 11 of the acoustic conversion module 10 is located in the accommodating portion 200, and the first outer casing 12 and the second outer casing 21 are coupled by a coupling member, so that the sound pickup module 20 is detachably coupled to the upper edge 11 of the acoustic conversion module 10. For example, the coupling member may be a screw (not shown) passing through a screw hole 15 of the first outer casing 12 and a screw hole 25 of the second outer casing 21 and being locked so that the sound pickup module 20 is detachably coupled to the acoustic conversion module 10. The combination of the sound pickup module 20 and the acoustic conversion module 10 is not limited to the position of the icon, and the sound pickup module 20 is detachably coupled to the middle or lower edge of the acoustic conversion module 10.

The first outer casing 12 of the acoustic conversion module 10 may enclose the sounding members of various speakers, such as drivers, diaphragms, voice coils, etc. (not shown). In addition, the acoustic conversion module 10 may also be a passive radiator, so that the first outer casing encloses the sounding assembly of the passive radiator, such as a loop, a diaphragm, etc. (not shown). The acoustic conversion module 10 may also be electrically connected to the sound pickup module 20 through a wire (not shown).

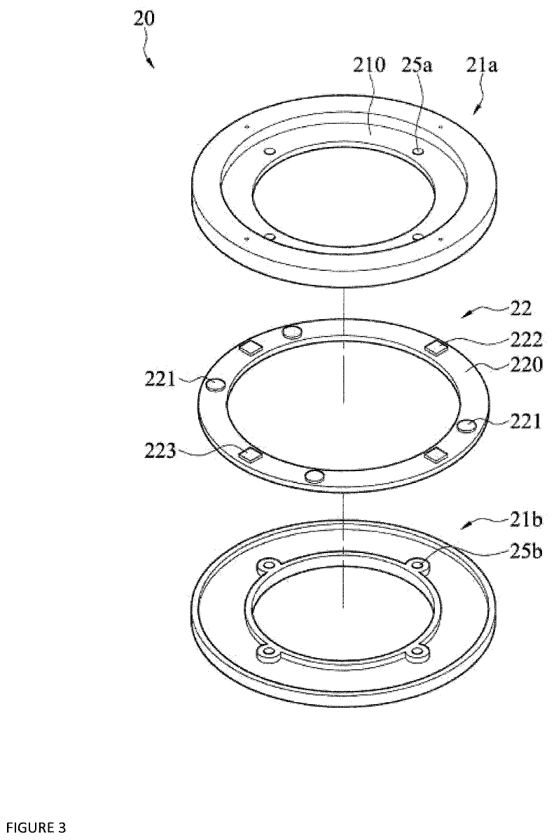

In an embodiment, as is illustrated in, for example, FIG. 3, the sound pickup module 10 includes a circuit assembly 22, and the circuit assembly 22 includes at least one microphone 221, such as two, four, or six, and the like. For example, the microphones 221 are arranged in an annular shape in an equidistant array. Since the microphone 221 is isolated from the acoustic conversion module 10, echo cancellation may be improved.

The second outer casing 21 includes an upper casing 21a and a lower casing 21b, and the upper casing 21a and the lower casing 21b enclose the circuit assembly 22 therein, and the upper casing 21a and the lower casing 21b are fixed by the screw holes 25a and 25b. Further, the circuit assembly 22 includes a circuit board 220 that may soldered with various electronic components, including a microphone 221.

In an embodiment, the circuit assembly 22 includes a processor 222, and the processor 222 is electrically coupled to microphone 221. The processor 222 is a digital signal processor. After the microphone 221 receives a sound, signal processing may be performed by the processor 222 to achieve the purpose of controlling the speaker with the sound.

In an embodiment, the circuit assembly 22 may further include a Bluetooth module and/or a network module (not shown) for communicating the processed signals with other apparatuses or devices for the purpose of controlling the speakers with the sound.

In an embodiment, the circuit assembly 22 includes an amplifier 223, and the amplifier 223 is coupled to processor 222 to amplify the signal.

Further, the circuit assembly 22 includes a PCB, and the above assemblies may be configured on the PCB to achieve a modular function.

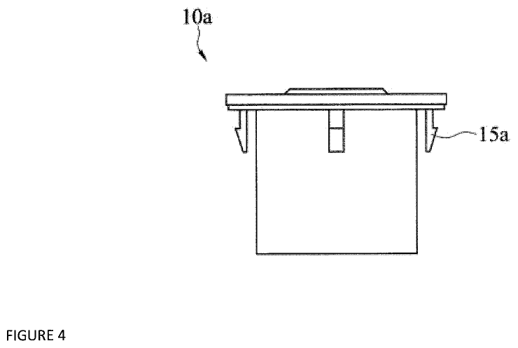

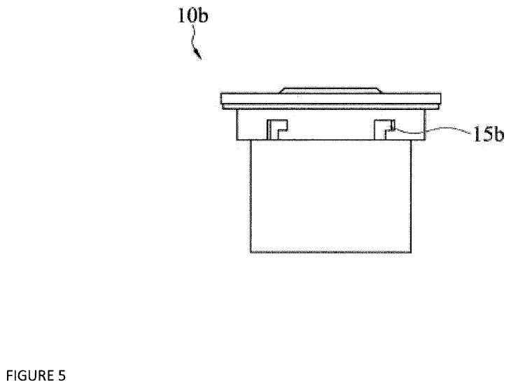

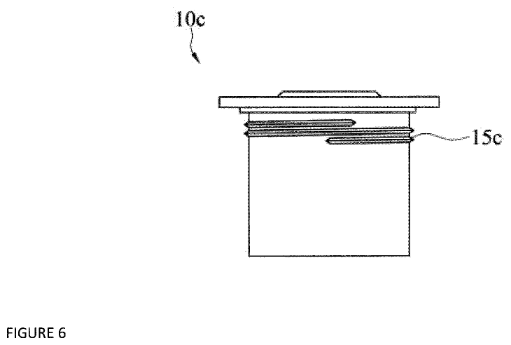

FIGS. 4-6 illustrate a front view of a an embodiment of coupling member, in a hook 15a, groove 15b and spiral snapping structure 15c, respectively, for a sound pick up module 10a, 10b and 10c, respectively, of the speaker of the present application, respectively. With reference to FIGS. 4-6, in an embodiment, the coupling member of the first outer casing 12 and the second outer casing 21 may be a hook structure 15a (FIG. 4), a groove structure 15b (FIG. 5), or a spiral snapping structure 15c (FIG. 6).

In the embodiments of FIGS. 1-3, the first outer casing 12 is substantially a circular cylindrical body, the second outer casing 21 is a corresponding circular annular body, and the second outer casing 21 is concentric with the first outer casing 12.

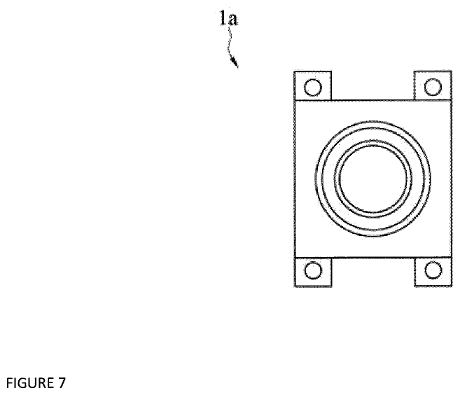

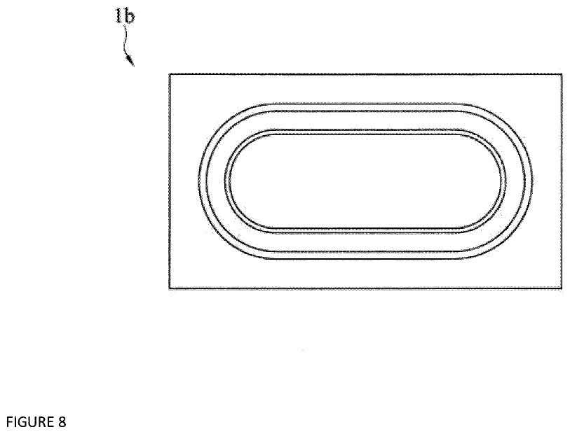

FIG. 7 is a view showing the first outer casing of a speaker 1a of the present application in a square shape. FIG. 8 is a view showing the first outer casing of a speaker 1b of the present application in an elliptical shape. With reference to FIGS. 7 and 8, in other embodiments, the first outer casing 12 may also be elliptical, square (FIG. 7) or rectangular (FIG. 8) cylindrical body, and the second outer casing is concentric with the first outer casing and is a elliptical, square or rectangular annular body.

Through the modular design, the sound pickup module 20 may be an option. If the function of the voice control is not required, the sound pickup module 20 is not required, and since the structure is simplified, the user may assemble and disassemble by himself. For those in the industry, it is more flexible to use various module increase and decrease functions, and it is also easier to manufacture with different sizes of acoustic conversion modules 10.

Although the present application has been disclosed in the above embodiments, it is not intended to limit the case. Any person skilled in the art can make some changes and refinements without departing from the spirit and scope of the application. Therefore, the scope of protection of the present application is subject to the scope defined by the appended claims.

1. A speaker, comprising:
an acoustic conversion module including a first outer casing that is cylindrical;
a sound pickup module including a second outer casing that is annular, the second casing including an accommodating portion; and
a coupling member;
wherein an upper edge of the acoustic conversion module is located at the accommodating portion and couples the first outer casing with the second outer casing by the coupling member to detachably couple the sound pickup module to the acoustic conversion module.

2. The speaker according to claim 1, wherein the sound pickup module includes a circuit assembly and the circuit assembly includes at least one microphone, and
wherein the second casing encloses the circuit assembly.

3. The speaker according to claim 2, wherein the circuit assembly includes a processor electrically coupled to the at least one microphone.

4. The speaker according to claim 3, wherein the circuit assembly includes a Bluetooth module electrically connected to the processor.

5. The speaker according to claim 2, wherein the circuit assembly includes a network module electrically coupled to the processor.

6. The speaker according to claim 3, wherein the circuit assembly includes an amplifier coupled to the processor.

7. The speaker according to claim 1, wherein the first outer casing is circular, elliptical, square or rectangular columnar, and the second outer casing is concentric with the first outer casing and is circular, elliptical, square or rectangular annular.

8. The speaker according to claim 1, wherein the coupling member includes a screw lock attachment.

9. The speaker according to claim 1, wherein the coupling member includes a hook structure, a groove structure, or a spiral engagement structure.

10. The speaker according to claim 1, wherein the first outer casing includes an upper edge extending outwardly, and the sound pickup module is detachably coupled to the upper edge of the acoustic conversion module.
